(19) United States
(12) Patent Application Publication
(10) Pub. No.: US 2019/0226587 A1
(43) Pub. Date: Jul. 25, 2019

(54) VALVE STEM WITH REMOVABLE HEAD

(71) Applicant: DDS INVESTMENTS, LLC, Junction City, KS (US)

(72) Inventor: Bryce W. Burris, Manhattan, KS (US)

(21) Appl. No.: 15/876,848

(22) Filed: Jan. 22, 2018

(51) Int. Cl. F16K 1/36; F16K 1/48; F16K 1/52; F16K 27/08; E21B 34/02

(52) U.S. Cl. CPC F16K 1/36; F16K 1/487; E21B 34/02; F16K 27/08; F16K 1/523

(57) ABSTRACT

A valve stem for use with a choke valve is disclosed. The valve stem has a valve stem body with a valve stem head removably connected to the valve stem body. A locking device prevents the unwanted loosening or removal of the valve stem head from the. valve stem body. The locking, device may be a fastener with a thread having a different direction than the thread that attaches the valve stem head to the valve stem body.

### BACKGROUND

Adjustable chokes are used in many industrial and oilfield applications to control the rate of flow. An adjustable choke is often utilized as a part of a manifold that is installed downstream of a well head. Adjustable choke valves comprise a valve body with a choke valve stem movable therein. The choke valve stem is movable relative to a seat in the choke valve body to regulate flow therethrough. The components that comprise the choke valve stem may be made from a variety of materials. Oftentimes the types of material utilized are dependent on the size of the choke valve orifice. For valves with two-inch orifices, the valve stem is often made from a single piece of metal. In other words, the choke valve stem may be machined from a single piece of stainless steel or other suitable materials. When utilizing a choke valve with a stem manufactured in this manner, the entire choke valve stem will have to be removed and replaced if the head thereof becomes worn or damaged.

### SUMMARY

A choke valve of the current disclosure comprises a choke valve body. The choke valve body defines a flow inlet, a flow outlet and a flow passage communicating the flow inlet with the flow outlet. A valve seat is defined in the valve seat body and positioned between the flow inlet and flow outlet. A choke valve stem with a generally cone-shaped valve stem head is disposed in the valve body. The valve stem is movable relative to the valve seat such that the space between the valve stem head and the valve seat is variable. In this way the valve stem is movable relative to the valve seat to regulate flow through the flow passage.

The valve stem comprises a valve stem body with a valve stem head threadedly connected thereto. The valve stem head may be for example a cone-shaped valve stem head. The valve stem head has an opening defined therethrough. A threaded fastener may extend through the opening in the valve stem head and be threaded into an end of the valve stem body.

The thread direction on the threaded fastener is opposite the direction of the threaded connection connecting the valve stem body to the valve stem head. Thus, the external thread to which the valve stem thread head is threaded has a different thread direction than the threads on the fastener which is threaded into an internal thread on the end of the valve stem body.

The choke valve stem thus comprises a valve stem body having an external thread on a first end thereof and a threaded opening in the first end. A valve stem head is threadedly connected to the external thread on the valve stem body. A fastener is threaded into the threaded opening in the valve stem body and is configured to prevent loosening of the valve stem head on the valve stem body. The opening in the valve stem head may define a shoulder and the head of the fastener may engage the shoulder thereon.

In another embodiment a choke valve includes a valve stem comprising a valve stem head threadedly connected to a valve stem body and a locking device to prevent premature removal or loosening of the valve stem head from the valve stem body. The locking device may comprise a threaded fastener that has a thread that is oppositely directed from an external thread on the valve stem body to which the valve stem head is threadedly connected.

### BRIEF DESCRIPTION OF THE DRAWINGS

FIG. 1 is a side view of a choke valve utilizing a valve stem with the current disclosure.

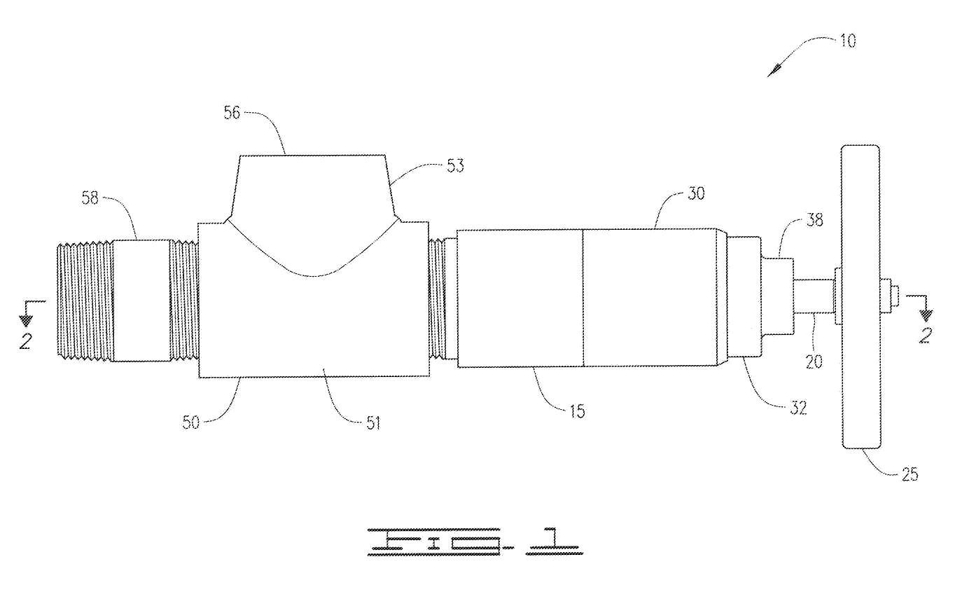

FIG. 2 is a cross section through line 2-2 in FIG. 1.

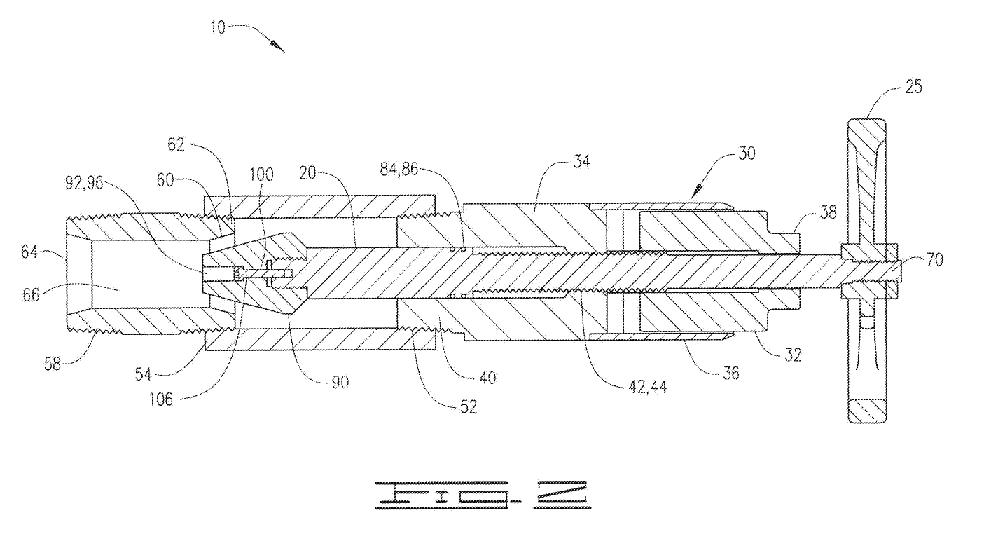

FIGS. 3A and 3B show a cross section of the valve stem with the removable head of the current disclosure.

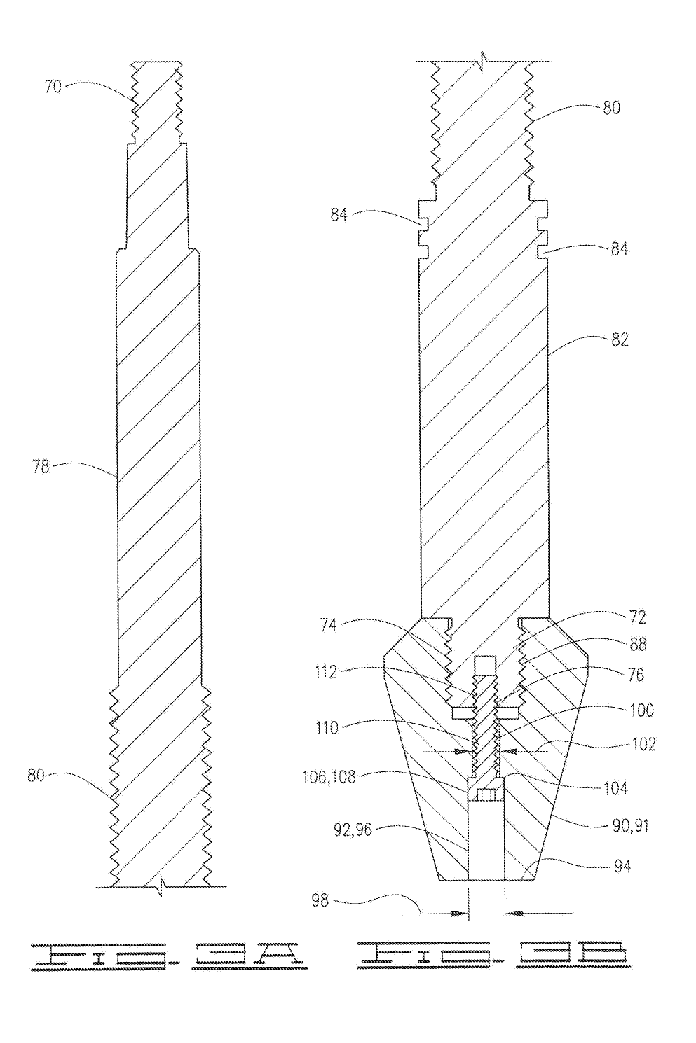

### DESCRIPTION OF EMBODIMENT

Referring now to the drawings, choke valve 10 comprises a valve body 15, a valve stem 20 disposed therein and an adjustment wheel 25 threadedly connected to valve stem 20. Choke valve 30 is of a type to be used in industrial and oilfield applications for the regulation of flow therethrough. Valve body 15 has an upper body portion 30. Upper body portion 30 comprises a choke indicator 32, a bonnet 34 and a sleeve or dust cover 36. Choke indicator 32 is received in sleeve 36 and rotates with valve stem 20. A set screw (not shown) will connect choke indicator 32 to valve stem 20 as is known in the art. Upper body portion 30 has upper end 38 and a lower end 40. Lower end 40, which is the lower end of bonnet 34, has threads 41 thereon. Valve body 15 defines a central opening 42 therethrough with a threaded neck portion 44. Threaded neck portion 44 threadedly connects to valve stem 20 so that rotation thereof will move valve stem 20 longitudinally in valve body 15 to regulate flow therethrough as explained in detail herein.

Bonnet 34 is threadedly connected to a tee union 50. Tee union 50 has a run 51 and rise 53. Run 51 has a threaded upper, or first end 52 and threaded lower or second end 54. Rise 53 defines an inlet 56 thereon. Tee union 50 is connected at first end 52 to bonnet 34. Threaded lower end or second end 54 of tee union 50 is connected to lower body portion 58 at threaded portion 60 thereon. Lower body portion 58 defines a seat 62 therein and an outlet 64. Flow path 66 connects inlet 56 with outlet 64. Seat 62 is positioned between inlet 56 and outlet 68 in flow path 66.

Choke valve stem 20 comprises a valve stem body 68 with first or upper end 70 threaded to adjustment wheel 25 and a second or lower end 72. Second end 72 has an external thread 74 thereon and has an internal thread 76 extending axially into lower end 72. External thread 74 and internal thread 76 are oppositely directed threads, meaning that one will have clockwise rotation to tighten and the other will have a counterclockwise rotation to tighten.

Valve stem body 68 has a first, or upper portion 78, a second or intermediate threaded portion 80 that is threaded to the threaded neck 44 in opening 42 and a third, or lower portion 82. Lower portion 82 has a plurality of grooves 84 thereon in which O-rings 86 may be received such that valve stem body 68 may be sealingly received in opening 42 in bonnet 34. A threaded neck 88 extends from lower portion 82 at the second end 72 of valve stem body 68.

Valve stem head 90 has an outer surface 91 which is a generally cone-shaped outer surface 91. An opening 92 which is a stepped opening extends from tip end 94 of valve stem head 90 completely through head 90 in the longitudinal, or axial direction. Stepped opening 92 has a first portion 96 with inner diameter 98 and second portion 100 with inner diameter 102 that is smaller than inner diameter 98. Opening 92 is a non-threaded opening.

First and second portions 96 and 100 of opening 92 define a shoulder 104 thereon. A fastener 106 with head 108 and shank 110 with threads 112 thereon extends through opening 92 and is threaded into internal thread 76 in valve stem body 68.

Fastener 106 comprises a locking device that prevents the inadvertent, premature or any unwanted loosening of valve stem head 90 from valve stem body 68. Because the threads 74 and 76 are oppositely directed threads, any rotation that would create a loosening of valve stem head 90 from valve stem 68 would be resisted by fastener 106 since the loosening rotation of valve stem head 90 would tend to cause a tightening rotation of fastener 106. The valve stem head 90 constitutes a removable valve head since the fastener 106 can be unthreaded and removed and then valve stem head 90 unthreaded. As a result, when valve stem head 90 is worn or damaged, it is not necessary to replace the entire valve stem, instead, replacement of valve stem head 90 is all that is required. Inadvertent or unwanted loosening or removal is not possible, since loosening rotation of valve stem head 90 will tighten fastener 106.

In operation, rotation of adjustment wheel 25 will move the valve stem 20 including valve stem head 90 longitudinally to vary the space between seat 62 and the outer surface 91 of the valve stem head 90. As a result flow through flow path 66 can be regulated. If valve stem head 90 wears it can easily be replaced simply by removing the threaded fastener 106 and unthreading valve stem head 90 and replacing valve stem head 90 with a new component.

Therefore, the present disclosure is well adapted to attain the ends and advantages mentioned, as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present disclosure. While apparatus and methods may be described in terms of “comprising,” “containing,” “having,” or “including” various components or steps, the apparatus and methods can also, in some examples, “consist essentially of” or “consist of” the various components and steps. Also, the terms in the claims have their plain, ordinary meaning unless otherwise explicitly and clearly defined by the specification.

What is claimed is:

1. A choke valve stem comprising:
a valve stem body;
a cone-shaped valve stem head threadedly connected to the valve stem body, the valve stem head having an opening defined therethrough; and
a threaded fastener extending through the opening in the valve stem head and threaded into an end of the valve stem body.

2. The choke valve stem of claim 1 wherein the thread direction on the threaded fastener is opposite the direction of the threads that connect the valve stem head to the valve stem body.

3. The choke valve stem of claim 1 wherein the threaded fastener prevents the valve stem head from rotating on the valve stem body.

4. The choke valve stem of claim 1 wherein the valve stem body has an external thread thereon to which the valve stem head is threaded, and wherein the thread direction of the external thread on the valve stem head is opposite the thread direction of an internal thread into which the threaded fastener is threaded.

5. A choke valve comprising:
a choke valve body defining a flow inlet, a flow outlet and a flow passage communicating the flow inlet and flow outlet;
a valve seat disposed in the valve body in the flow passage between the flow inlet and the flow outlet;
a valve stem movable relative to the valve seat for regulating flow through the flow passage valve stem comprising:
a valve stem body;
a valve stem head removably connected to the valve stem body; and
a locking device configured to prevent premature removal or loosening of the valve stem head from the valve stem body.

6. The choke valve of claim 5, wherein, the valve stem head is threaded to an external thread defined on the valve stem body.

7. The choke valve of claim 6, wherein the locking mechanism comprises a threaded fastener, and wherein the threaded fastener extends through an opening in the valve stem head and is threaded into an internal thread in an end of the valve stem body.

8. The choke valve of claim 7, wherein the external thread and the internal thread on the valve stem body axe oppositely directed threads.

9. The choke valve of claim 5, wherein, the valve stem head is threadedly connected to the valve stem body, and wherein the locking device is a threaded fastener extending through the valve stem head and threadedly connected to the valve stem body.

10. The choke valve of claim 9, wherein, the rotational direction required to remove the valve stem head from the valve stem body is opposite the rotational direction required to remove the threaded fastener from the valve stem body.

11. A choke valve stem comprising:
a valve stem body having first and second ends, and having an external thread and an internal thread at the second end thereof;
a valve stem head threadedly connected to the external thread on the valve stem body; and
a fastener threaded into the threaded opening in the valve stem body and configured to prevent loosening of the valve stem head on the valve stem body.

12. The choke valve stem of claim 11, wherein the valve stem head defines an opening therethrough, and wherein the threaded fastener extends through the opening in the valve stem head.

13. The choke valve stem of claim 12, wherein the opening in the valve stem head defines a shoulder, and wherein a head of the threaded fastener engages the shoulder.

14. The choke valve of claim 13, wherein the external thread and the internal thread at the second end of the valve stem head are oppositely directed threads.

15. The choke valve of claim 11, wherein rotation of the valve stem head to loosen the valve stem head from the valve stem body will simultaneously cause a tightening rotation of the threaded fastener.
